(19) United States
(12) Patent Application Publication
(10) Pub. No.: US 2022/0405639 A1
(43) Pub. Date: Dec. 22, 2022

(54) INFORMATION PROCESSING APPARATUS, INFORMATION PROCESSING METHOD AND PROGRAM

(71) Applicant: NIPPON TELEGRAPH AND TELEPHONE CORPORATION, Tokyo (JP)

(72) Inventors: Kosuke NISHIDA, Tokyo (JP); Kyosuke NISHIDA, Tokyo (JP); Itsumi SAITO, Tokyo (JP); Hisako ASANO, Tokyo (JP); Junji TOMITA, Tokyo (JP)

(73) Assignee: NIPPON TELEGRAPH AND TELEPHONE CORPORATION, Tokyo (JP)

(21) Appl. No.: 17/770,953

(22) PCT Filed: Nov. 21, 2019
(86) PCT No.: PCT/JP2019/045663

§ 371 Date: Apr. 21, 2022

(51) Int. Cl. G06N 20/00

(52) U.S. Cl. CPC G06N 20/00

(57) ABSTRACT

An information processing apparatus includes a training unit configured to share encoding layers from a first layer to a (N-n)-th layer having parameters trained in advance by a first model and a second model, and train parameters of a third model through multi-task training including training of the first model and retraining of the second model for a predetermined task, wherein N and n are integers equal to or greater than 1, and satisfies N>n, and in the third model, encoding layers from an ((N-n)+1)-th layer to an N-th layer having parameters trained in advance are divided into the first model and the second model.

### TECHNICAL FIELD

The present invention relates to an information processing apparatus, an information processing method, and a program.

### BACKGROUND ART

In recent years, a task referred to as machine reading comprehension for responding to a question for a sentence using artificial intelligence (AI) has been attracting attention due to the development of deep learning technology, preparation of data sets, and the like. When a model for a machine reading comprehension task (a machine reading comprehension model) is trained, it is necessary to create training data for a machine reading comprehension task on a scale of tens of thousands of cases. Thus, it is necessary to create a large amount of supervised data in a domain that is a use target of machine reading comprehension in order to actually use the machine reading comprehension. The domain is a theme, subject, genre, topic, or the like to which a sentence belongs.

Here, because an annotation of a sentence required for creation of supervised data is generally expensive, a cost for creation of supervised data often becomes a problem when a service using a machine reading comprehension task is provided. For such a problem, it is known that the number of pieces of training data for this language processing task can be reduced by fine-tuning a pretrained language model BERT (NPL 1) or XLnet (NPL 2) using an ultra-large corpus for a specific language processing task.

### CITATION LIST

### Non Patent Literature

NPL 1: Jacob Devlin, Ming-Wei Chang, Kenton Lee, Kristina Toutanova, “BERT: Pretraining of Deep Bidirectional Transformers for Language Understanding”. NPL 2: Zhilin Yang, Zihang Dai, Yiming Yang, Jaime Carbonell, Ruslan Salakhutdinov, Quoc V. Le, “XLNet: Generalized Autoregressive Pretraining for Language Understanding”.

### SUMMARY OF THE INVENTION

### Technical Problem

However, when a pretrained language model is fine-tuned for a machine reading comprehension task, generalization performance of a machine reading comprehension task may decrease. For example, when BERT is fine-tuned using training data for a machine reading comprehension task, accuracy of machine reading comprehension may decrease in a domain not included in the training data.

An object of one embodiment of the present invention is to alleviate reduction of generalization performance when a pretrained language model is fine-tuned.

### Means for Solving the Problem

In order to achieve the above object, an information processing apparatus according to the present embodiment includes a training unit configured to share encoding layers from a first layer to a (N-n)-th layer having parameters trained in advance by a first model and a second model, and train parameters of a third model through multi-task training including training of the first model and retraining of the second model for a predetermined task, wherein N and n are integers equal to or greater than 1, and satisfies N>n, and in the third model, encoding layers from an ((N-n)+1)-th layer to an N-th layer having parameters trained in advance are divided into the first model and the second model.

### Effects of the Invention

It is possible to curb the deterioration of generalization performance when a pretrained language model is fine-tuned.

### BRIEF DESCRIPTION OF DRAWINGS

FIG. 1 is a diagram illustrating an example of a model configuration at the time of training.

FIG. 2 is a diagram illustrating an example of an overall configuration of a question responding device at the time of training.

FIG. 3 is a diagram illustrating an example of the overall configuration of the question responding device at the time of inference.

FIG. 4 is a diagram illustrating an example of a hardware configuration of the question responding device according to the present embodiment.

FIG. 5 is a flowchart (1/2) illustrating an example of training processing according to the present embodiment.

FIG. 6 is a flowchart (2/2) illustrating the example of training processing according to the present embodiment.

FIG. 7 is a flowchart illustrating an example of question responding processing according to the present embodiment.

### DESCRIPTION OF EMBODIMENTS

Hereinafter, an embodiment of the present invention will be described. In the present embodiment, as an example, a question responding device 10 in which a machine reading comprehension task for performing a response (answer) to a question for a sentence is assumed, and a pretrained language model is fine-tuned for a machine reading comprehension task, so that reduction of generalization performance of a machine reading comprehension model can be alleviated when a machine reading comprehension model is trained will be described. The machine reading comprehension task is a task of extracting a character string in a range of answers to a question in a sentence.

Here, for example, when BERT is fine-tuned using training data for a machine reading comprehension task and a machine reading comprehension model is trained, the accuracy of machine reading comprehension may decrease in a domain not included in the training data, as described above. This is because the accuracy of machine reading comprehension decreases in a domain not included in the training data (for example, a domain that is actually a use target in machine reading comprehension (hereinafter also referred to as a “target domain”)) due to high dependence on a domain of training data used for fine tuning (hereinafter also referred to as a “source domain”) (that is, due to reduction of generalization performance). On the other hand, a large amount of training data is created in the target domain and fine tuning is performed using the training data so that the deterioration of generalization performance can be curbed, but it is necessary to create a large amount of supervised data for a sentence of the target domain, which increases the cost, as described above.

Thus, in the present embodiment, fine tuning of the machine reading comprehension model is performed on the source domain for which the training data is easily available through supervised training, and retraining of the language model is performed on the target domain for which there is no supervised data through unsupervised training. This makes it possible to alleviate reduction of the accuracy of the machine reading comprehension model in this target domain (that is, reduction of generalization performance) without creating supervised data in the target domain.

Model Configuration

First, a configuration of a model that is a training target in the present embodiment will be described. It is known that, when a pretrained language model such as BERT or XLnet has been fine-tuned for a certain task, feature quantities (for example, part-of-speech information) common to tasks are trained on lower layers (that is, encoding layers closer to an input) among encoding layers constituting the pretrained language model, and feature quantities specific to a task are trained on higher layers (that is, encoding layers close to an output) (Reference 1).

[Reference 1]

Ian Tenney, Dipanjan Das, Ellie Pavlick, “BERT Rediscovers the Classical NLP Pipe line”. Thus, in the present embodiment, higher layers among the encoding layers constituting the pretrained language model are divided into a language model and a machine reading comprehension model, and in lower layers, a model common to the language model and the machine reading comprehension model is set to a training target. In the present embodiment, the model that is a training target is trained through multi-task training of fine tuning using supervised training of a machine reading comprehension task and retraining using unsupervised training of the language model.

Hereinafter, as an example, the pretrained language model is assumed to be BERT. Further, it is assumed that the BERT includes a total of N blocks of transformer layers (that is, a total of N encoding layers). However, the present embodiment is similarly applicable to any pretrained language model such as XLnet.

Further, training of the pretrained language model (multitask training) will be described using BERT as an example. When a pretrained language model other than BERT is adopted, an input, output, and training method at the time of training according to the adopted pretrained language model is used.

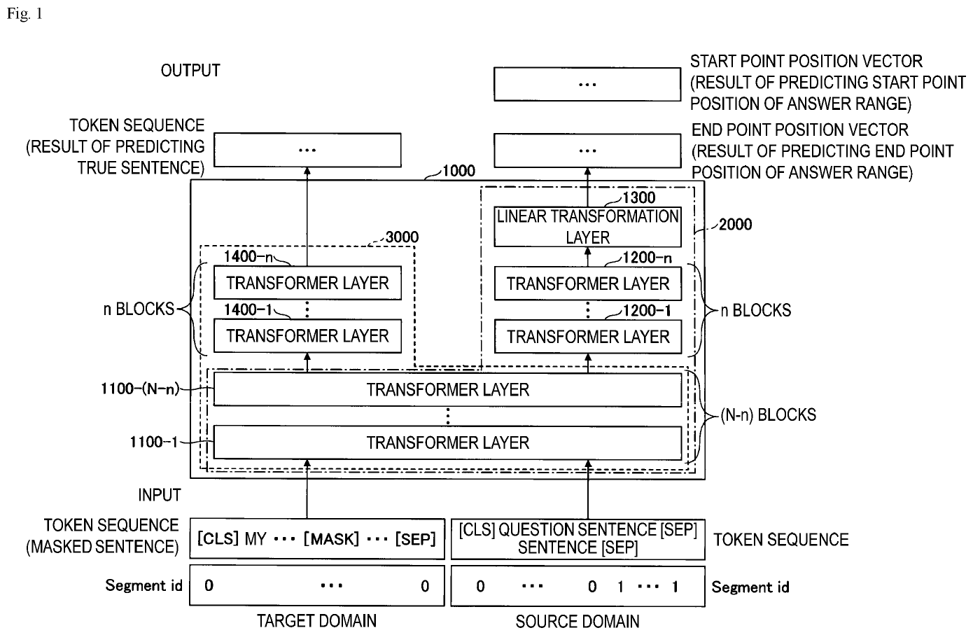

A configuration of the model 1000 that is a training target is illustrated in FIG. 1. FIG. 1 is a diagram illustrating an example of a model configuration at the time of training.

As illustrated in FIG. 1, the model 1000 that is a training target in the present embodiment includes transformer layers 1100-1 to 1100-(N-n), transformer layers 1200-1 to 1200-n, a linear transformation layer 1300, and transformer layers 1400-1 to 1400-n.

The transformer layers 1100-1 to 1100-(N-n) are encoding layers common to the language model and the machine reading comprehension model. Here, n is an integer satisfying 1<n<N, and is a parameter (hyperparameter) preset by a user or the like.

The transformer layers 1200-1 to 1200-n are encoding layers of the language model.

The linear transformation layer 1300 is a layer that linearly transforms an output of the transformer layer 1200-n. The linear transformation layer 1300 is an example, and any relatively simple neural network may be used instead of the linear transformation layer 1300.

The transformer layers 1400-1 to 1400-n are encoding layers of the machine reading comprehension model.

In this case, the transformer layers 1100-1 to 1100-(N-n), the transformer layers 1200-1 to 1200-n, and the linear transformation layer 1300 constitute a machine reading comprehension model 2000. A language model 3000 includes the transformer layers 1100-1 to 1100-(N-n) and the transformer layers 1400-1 to 1400-n. Initial values of the parameters of the respective transformer layers of the machine reading comprehension model 2000 and the language model 3000 at the time of multi-task training become values of parameters of respective transformer layers of BERT. That is, initial values of the parameters of the transformer layers 1100-1 to 1100-(N-n) of the machine reading comprehension model 2000 and the language model 3000 at the time of multi-task training become values of parameters of transformer layers of the first block to (N-n)-th blocks of BERT respectively. Similarly, both of the initial values of the parameters of transformer layers 1200-1 to 1200-n of the machine reading comprehension model 2000 and the initial values of the parameters of transformer layers 1400-1 to 1400-n of the language model 3000 become values of the parameters of the transformer layers from an ((N-n)+1)-th block to an N-th block of BERT.

When the language model 3000 is retrained, a token sequence consisting of a token [CLS], a sentence in which a part of a sentence of the target domain has been masked (hereinafter also referred to as a “masked sentence”), and a token [SEP], and a segment id of all 0s are input to the language model 3000, and an error between a token sequence obtained for an output thereof (that is, a result of predicting a true sentence) and the true sentence is used to train the language model 3000. The true sentence is also referred to as a sentence before the masked sentence was masked (hereinafter also referred to as a “pre-masked sentence”). A token is a character string representing a component of a sentence such as one word or one part of speech, a character string representing a special meaning, or the like. [CLS], [MASK], [SEP], and the like are tokens representing special meanings, [CLS] is a token representing a beginning of a sentence, [MASK] is a token representing a masked location, and [SEP] is a token representing an end of a sentence or a delimiter of the sentence. Further, the masked sentence is, more accurately, a token sequence representing the sentence of the target domain and having some of the tokens replaced with [MASK].

On the other hand, when the machine reading comprehension model 2000 is trained (that is, fine-tuned), a token sequence consisting of a token [CLS], a question sentence, a token [SEP], a sentence of the source domain, and a token [SEP], and a segment id that has 0s in series from [CLS] to a first [SEP] and is in series from the sentence to a second [SEP] are input to the machine reading comprehension model 2000, and an error between a start point position vector and an end point position vector obtained for an output and a true answer range is used to train the machine reading comprehension model 2000. The start point position vector is a vector representing a start point of an answer range (more accurately, a probability distribution that becomes the start point of the answer range), which is an answer part in a sentence with respect to a question, and is a vector with the same number of dimensions as an input length (that is, the number of tokens in an input token sequence). The end point position vector is a vector representing an end point of the answer range (more accurately, a probability distribution that becomes an end point of the answer range), and is a vector having the same number of dimensions as the input length. The true answer range is a correct answer (that is, supervised data) to the question. Further, the question sentence is more accurately a token sequence representing the question sentence and the sentence of the source domain is more accurately, a token sequence representing the sentence of the source domain.

Thus, at the time of retraining the language model 3000, only a masked language model is trained using a segment id consisting of all 0s and next sentence prediction is not performed. This makes it possible to specialize an understanding of an interrelationship between two inputs using the segment id for machine reading comprehension, and curb a negative influence of the training of the language model 3000 on training of the machine reading comprehension model 2000.

The question responding device 10 according to the present embodiment trains, for example, the model 1000 illustrated in FIG. 1 through multitask training at the time of training. Thus, the machine reading comprehension model 2000 in which the lower layers (the transformer layers 1100-1 to 1100(N-n)) have been retrained in the target domain is obtained. The question responding device 10 according to the present embodiment uses the machine reading comprehension model 2000 to perform a question response (machine reading comprehension task) at the time of inference.

The machine reading comprehension model 2000 is an example of a first model described in the claims. The language model 3000 is an example of a second model described in the claims. The model 1000 is an example of a third model described in the claims.

Further, masking a part of the sentence is an example of processing described in the claims. Processing to be performed on a sentence is determined according to a pretrained language model that is adopted or the like. Examples of processing other than masking include replacement with a random word (token).

Overall Configuration of Question Responding Device 10

Next, an overall configuration of the question responding device 10 according to the present embodiment will be described.

At Time of Training

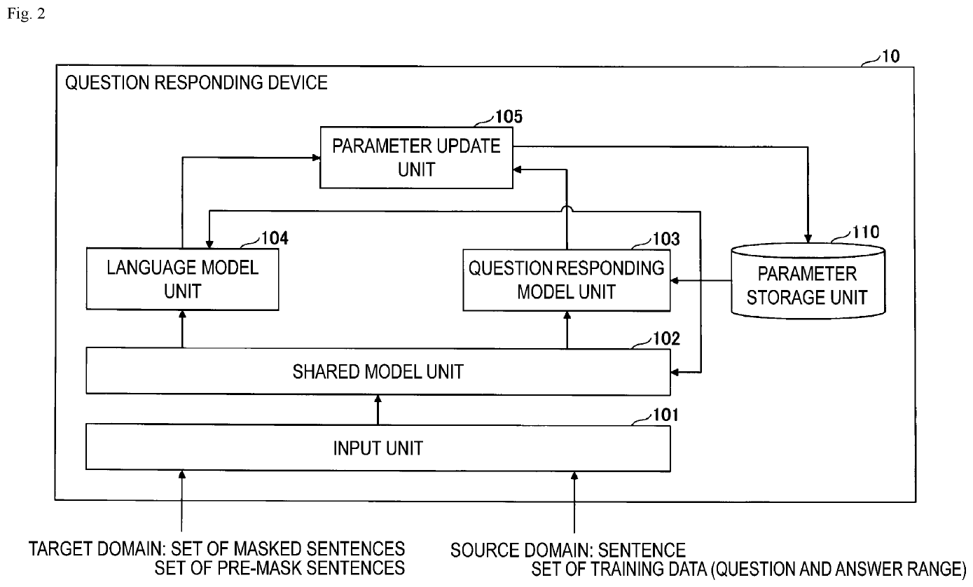

The overall configuration of the question responding device 10 at the time of training will be described with reference to FIG. 2. FIG. 2 is a diagram illustrating an example of the overall configuration of the question responding device 10 at the time of training.

As illustrated in FIG. 2, the question responding device 10 at the time of training includes an input unit 101, a shared model unit 102, a question responding model unit 103, a language model unit 104, a parameter update unit 105, and a parameter storage unit 110.

The input unit 101 receives a set of sentences and training data of the source domain, and a set of pre-masked sentences and a set of masked sentences of the target domain. The training data includes a question (question sentence) and an answer range (that is, supervised data) in the sentence for this question.

The shared model unit 102 receives, as inputs, a token sequence corresponding to the sentence input via the input unit 101 and the question sentence included in the training data, and a segment id corresponding to the token sequence, and uses the parameters stored in the parameter storage unit 110 to output an intermediate expression at the time of fine tuning of the machine reading comprehension model 2000. On the other hand, the shared model unit 102 receives, as inputs, the token sequence corresponding to the masked sentence input via the input unit 101 and a segment id corresponding to the token sequence and outputs an intermediate expression at the time of retraining the language model 3000. The shared model unit 102 is realized by the transformer layers 1100-1 to 1100-(N-n) included in the model 1000 illustrated in FIG. 1.

The question responding model unit 103 receives, as an input, the intermediate expression output from the shared model unit 102 at the time of fine tuning of the machine reading comprehension model 2000, and uses the parameters stored in the parameter storage unit 110 to output the start point position vector and the end point position vector (or output a matrix composed of the start point position vector and the end point position vector). The question responding model unit 103 is realized by the transformer layers 1200-1 to 1200-n and the linear transformation layer 1300.

The language model unit 104 receives, as an input, the intermediate expression output from the shared model unit 102 at the time of retraining the language model 3000, and uses the parameters stored in the parameter storage unit 110 to output a token sequence representing a result of predicting the pre-masked sentence. The language model unit 104 is realized by the transformer layers 1400-1 to 1400-n.

The parameter update unit 105 updates (trains) the parameters of the shared model unit 102 and the parameters of the question responding model unit 103 at the time of fine tuning of the machine reading comprehension model 2000 by using an error between an answer range specified by the start point position vector and the end point position vector output from the question responding model unit 103 and an answer range included in the training data. The parameters of the shared model unit 102 are the parameters of the transformer layers 1100-1 to 1100-(N-n). The parameters of the question responding model unit 103 are the parameters of the transformer layers 1200-1 to 1200-n and the linear transformation layer 1300.

On the other hand, at the time of retraining the language model 3000, the parameter update unit 105 updates (trains) the parameters of the shared model unit 102 and the parameters of the language model unit 104 by using an error between a token sequence output from the language model unit 104 (that is, the token sequence representing the result of predicting the pre-masked sentence) and a token sequence representing the pre-masked sentence. The parameters of the language model unit 104 are parameters of the transformer layers 1400-1 to 1400-n.

The parameter storage unit 110 stores the parameters of the model 1000 that is a training target (that is, the parameters of the shared model unit 102, the parameters of the question responding model unit 103, and the parameters of the language model unit 104).

At Time of Inference

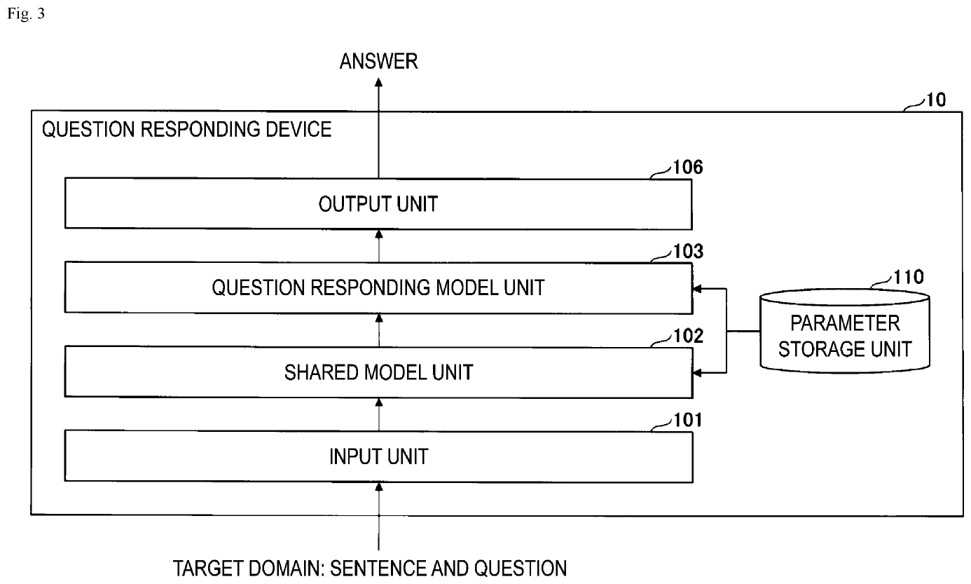

An overall configuration of the question responding device 10 at the time of inference will be described with reference to FIG. 3. FIG. 3 is a diagram illustrating an example of the overall configuration of the question responding device 10 at the time of inference.

As illustrated in FIG. 3, the question responding device 10 at the time of inference includes the input unit 101, the shared model unit 102, the question responding model unit 103, the output unit 106, and the parameter storage unit 110. The trained parameters (that is, at least the trained parameters of the shared model unit 102 and the trained parameters of the question responding model unit 103) are stored in the parameter storage unit 110.

The input unit 101 receives, as an input, a question and a sentence of the target domain. The shared model unit 102 receives, as an input, a token sequence corresponding to the sentence and the question sentence input via the input unit 101, and uses the trained parameters stored in the parameter storage unit 110 to output an intermediate expression. The question responding model unit 103 receives, as an input, the intermediate expression output from the shared model unit 102, and uses the trained parameters stored in the parameter storage unit 110 to output the start point position vector and the end point position vector (or, outputs a matrix composed of the start point position vector and the end point position vector).

The output unit 106 extracts a character string corresponding to the answer range indicated by the start point position vector and the end point position vector output from the question responding model unit 103 from the sentence, and outputs the character string as an answer to a predetermined output destination. The output destination may be any output destination and, for example, the character string may be displayed on a display, a sound corresponding to the character string may be output from a speaker, or data representing the character string may be stored in an auxiliary storage device or the like.

In the present embodiment, the same question responding device 10 executes the training and the inference, but the present invention is not limited thereto and the training and the inference may be executed by different devices. For example, a training device may execute training, and a question responding device different from this training device may execute the inference.

Hardware Configuration of Question Responding Device 10

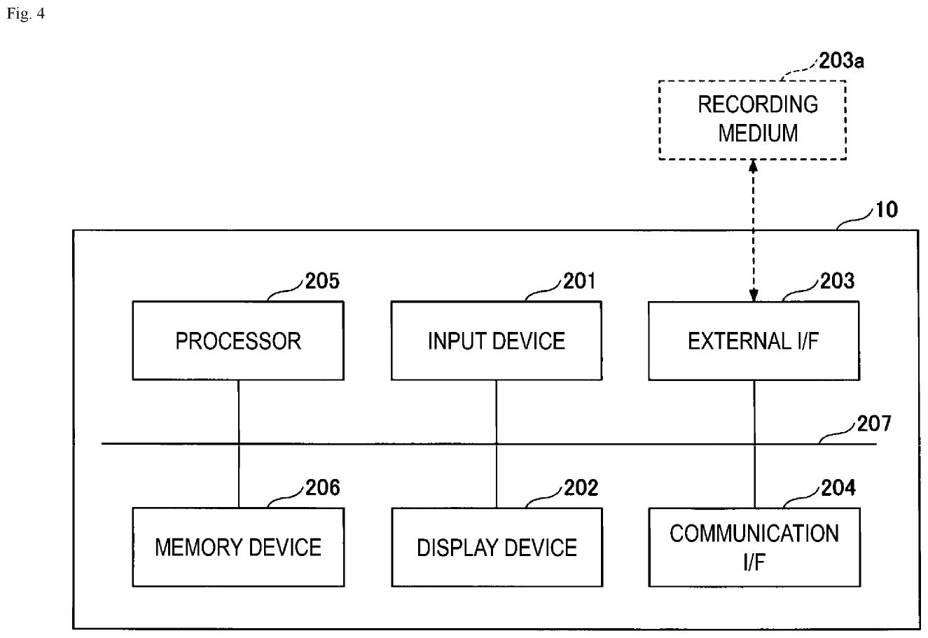

Next, a hardware configuration of the question responding device 10 according to the present embodiment will be described with reference to FIG. 4. FIG. 4 is a diagram illustrating an example of the hardware configuration of the question responding device 10 according to the present embodiment.

As illustrated in FIG. 4, the question responding device 10 according to the present embodiment is implemented by a general computer (information processing unit), and includes an input device 201, a display device 202, an external I/F 203, a communication I/F 204, a processor 205, and a memory device 206. The pieces of hardware are communicatively connected via a bus 207.

The input device 201 is, for example, a keyboard, a mouse, or a touch panel. The display device 202 is, for example, a display. The question responding device 10 may not include at least one of the input device 201 and the display device 202.

The external I/F 203 is an interface with an external device. The external device includes a recording medium 203a or the like. One or more programs that realize, for example, respective functional units (the input unit 101, the shared model unit 102, the question responding model unit 103, the language model unit 104, parameter update unit 105, and the like) included in the question responding device 10 at the time of training may be stored in the recording medium 203a. Similarly, for example, one or more programs that realize the functional units (the input unit 101, the shared model unit 102, the question responding model unit 103, the output unit 106, and the like) included in the question responding device 10 at the time of inference may be stored in the recording medium 203a.

Examples of the recording medium 203a include a compact disc (CD), a digital versatile disk (DVD), a secure digital memory card (SD memory card), and a universal serial bus (USB) memory card.

The communication I/F 204 is an interface for connecting the question responding device 10 to the communication network. One or more programs that realize respective functional units of the question responding device 10 at the time of training or inference may be acquired (downloaded) from a predetermined server device or the like via the communication I/F 204.

The processor 205 is, for example, various calculation devices such as a central processing unit (CPU) or a graphics processing unit (GPU). One or more programs that realize respective functional units included in the question responding device 10 at the time of training or inference are realized by processing for causing the processor 205 to execute one or more programs stored in the memory device 206 or the like.

The memory device 206 is, for example, any storage device such as a hard disk drive (HDD), a solid state drive (SSD), a random access memory (RAM), a read only memory (ROM), or a flash memory. The parameter storage unit 110 included in the question responding device 10 at the time of training and inference can be realized by using a memory device 306.

The question responding device 10 at the time of training has the hardware configuration illustrated in FIG. 4, making it possible to realize training processing to be described below. Similarly, the question responding device 10 at the time of inference has the hardware configuration illustrated in FIG. 4, making it possible to realize question responding processing to be described below. The hardware configuration illustrated in FIG. 4 is an example, and the question responding device 10 may have another hardware configuration. For example, the question responding device 10 may include a plurality of processors 205 or may include a plurality of memory devices 206.

Flow of Training Processing

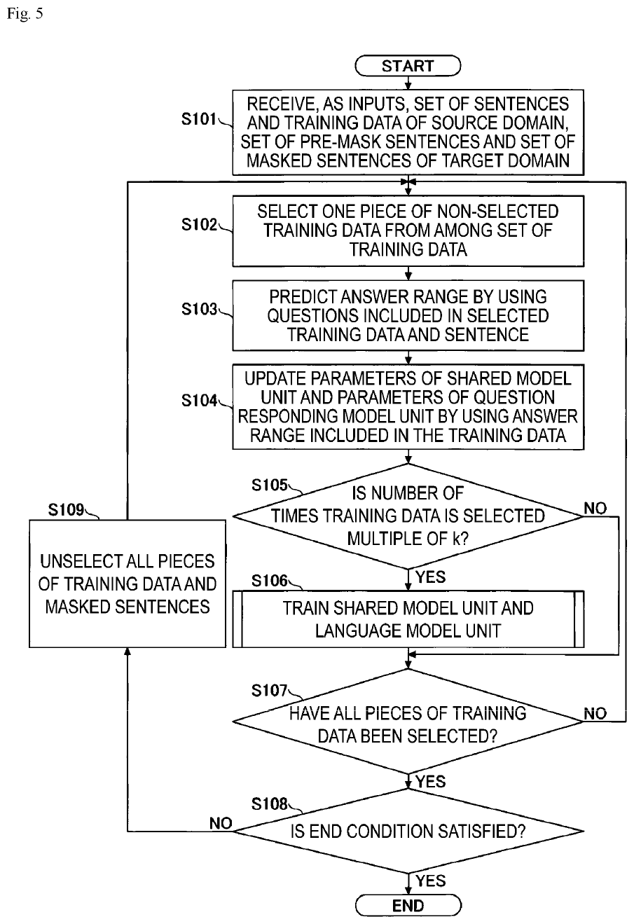

Next, a flow of the training processing according to the present embodiment will be described with reference to FIG. 5. FIG. 5 is a flowchart (1/2) illustrating an example of the training processing according to the present embodiment.

First, the input unit 101 receives, as inputs, a set of sentence of the source domain and training data, and a set of pre-masked sentences and a set of masked sentences of the target domain (step S101).

Then, the input unit 101 selects one piece of non-selected training data from among the set of training data input in step S101 above (step S102).

Next, the shared model unit 102 and the question responding model unit 103 predicts the answer range in the sentence for the question by using a question (question sentence) included in the training data selected in step S102, the sentence of the source domain, and the parameters stored in the parameter storage unit 110 (step S103).

That is, first, the shared model unit 102 receives, as inputs, a token sequence corresponding to the question sentence and the sentence of the source domain (that is, token sequence consisting of a token sequence representing [CLS] and the question sentence, a token sequence representing [SEP] and the sentence of the source domain, and [SEP]), and a segment id corresponding to the token sequence, and uses the parameters stored in the parameter storage unit 110 to output an intermediate expression. The segment id corresponding to the token sequence is a segment id that has 0s in series from [CLS] to a first [SEP] and is in series from the sentence to a second [SEP]. Then, the question responding model unit 103 receives, as an input, the intermediate expression output from the shared model unit 102, and uses the parameters stored in the parameter storage unit 110 to output the start point position vector and the end point position vector (or output a matrix composed of the start point position vector and the end point position vector). Accordingly, the range specified by a start point indicated by the start point position vector and an end point indicated by the end point position vector is predicted as the answer range in the sentence for the question.

Then, the parameter update unit 105 updates (trains) the parameters of the shared model unit 102 and the parameters of the question responding model unit 103 among the parameters stored in the parameter storage unit 110 by using the error between the answer range predicted in step S103 and the answer range included in the training data selected in step S102 (step S104). The parameter update unit 105 may calculate the error using a known error function such as a cross entropy error function, and update the parameters of the shared model unit 102 and the parameters of the question responding model unit 103 so that the error is minimized. Thus, the machine reading comprehension model 2000 is fine-tuned through supervised training.

Then, the input unit 101 determines whether or not the number of times the training data is selected in step S102 above is a multiple of k (step S105). Here, k is any integer equal to or greater than 1, and is a parameter (hyperparameter) preset by a user or the like.

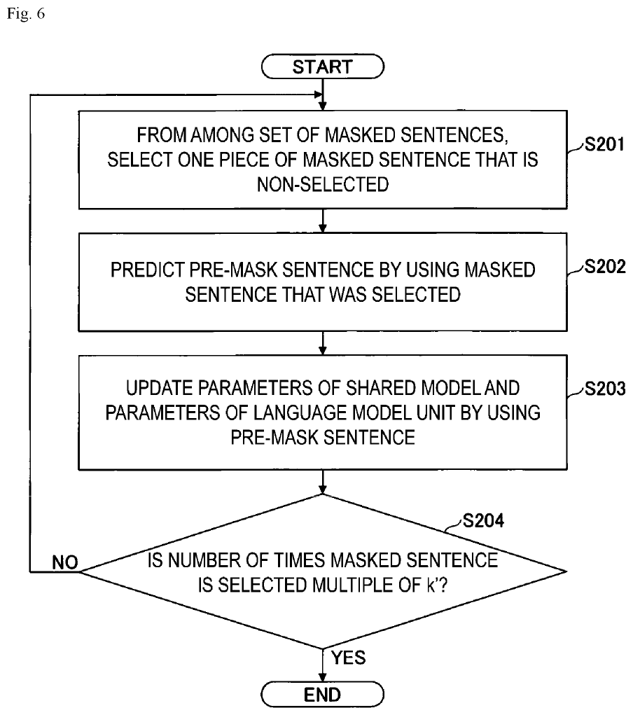

When a determination is made in step S105 that the number of times the training data is selected is a multiple of k, the question responding device 10 trains the shared model unit 102 and the language model unit 104 (that is, the language model 3000 is retrained through unsupervised training) (step S106). Details of processing of this step will be described with reference to FIG. 6. FIG. 6 is a flowchart (2/2) illustrating an example of the training processing according to the present embodiment.

From among the set of masked sentences input in step S101 above, the input unit 101 selects one piece of masked sentence that is non-selected (step S201).

Then, the shared model unit 102 and the language model unit 104 predict the pre-masked sentence by using the masked sentence selected in step S201 and the parameters stored in the parameter storage unit 110 (step S202).

That is, first, the shared model unit 102 receives, as inputs, a token sequence corresponding to the masked sentence (that is, a token sequence consisting of [CLS], a token sequence representing the masked sentence, and [SEP]), and a segment id corresponding to this token sequence (that is, a segment id of all 0s), and uses the parameters stored in the parameter storage unit 110 to output the intermediate expression. Then, the language model unit 104 receives, as an input, the intermediate expression output from the shared model unit 102 and uses the parameters stored in the parameter storage unit 110 to output the token sequence representing the result of predicting the pre-masked sentence. This allows the pre-masked sentence to be predicted.

Then, the parameter update unit 105 updates (trains) the parameters of the shared model unit 102 and the parameters of the language model unit 104 among the parameters stored in the parameter storage unit 110 by using an error between the token sequence representing the pre-masked sentence corresponding to the masked sentence selected in step S201 and the token sequence representing the pre-masked sentence predicted in step S202 (step S203). The parameter update unit 105 may calculate the error using a known error function such as a mean masked LM likelihood, and updates the parameters of the shared model unit 102 and the parameters of the language model unit 104 so that the error is minimized. Thus, the language model 3000 is retrained through unsupervised training.

Next, the input unit 101 determines whether or not the number of times the masked sentence is selected in step S201 is a multiple of k′ (step S204). k′ is any integer equal to or greater than 1, and is a parameter (hyperparameter) preset by a user or the like.

When a determination is not made in step S204 that the number of times the masked sentence is selected is a multiple of k′, the input unit 101 returns to step S201. Thus, steps S201 to S204 are repeatedly executed until the number of times the masked sentence is selected in step S201 is a multiple of k′. On the other hand, when a determination is made in step S204 that the number of times the masked sentence is selected is a multiple of k′, the question responding device 10 ends the training processing of FIG. 6 and proceeds to step S107 of FIG. 5.

Return to the description of FIG. 5. Following step S106 or when a determination is not made in step S105 that the number of times the training data is selected is a multiple of k, the input unit 101 determines whether or not all pieces of the training data have been selected (step S107).

When a determination is not made in step S107 that all pieces of the training data have been selected (that is, when there is unselected training data in the set of training data), the input unit 101 returns to step S102 above. Accordingly, steps S102 to S107 above are repeatedly executed until all pieces of the training data included in the set of training data input in step S101 above are selected.

On the other hand, when a determination is made in step S107 that all pieces of the training data have been selected, the input unit 101 determines whether or not a predetermined end condition is satisfied (step S108). Here, examples of the predetermined end condition may include that a total number of times steps S102 to S108 above are repeatedly executed is equal to or greater than a predetermined number of times.

When a determination is made in step S108 above that the predetermined end condition is satisfied, the question responding device 10 ends the training processing.

On the other hand, when a determination is not made in step S108 above that the predetermined end condition is satisfied, the input unit 101 does unselect all pieces of the training data and all the masked sentences (step S109). Thus, the training processing is executed again from step S102 above.

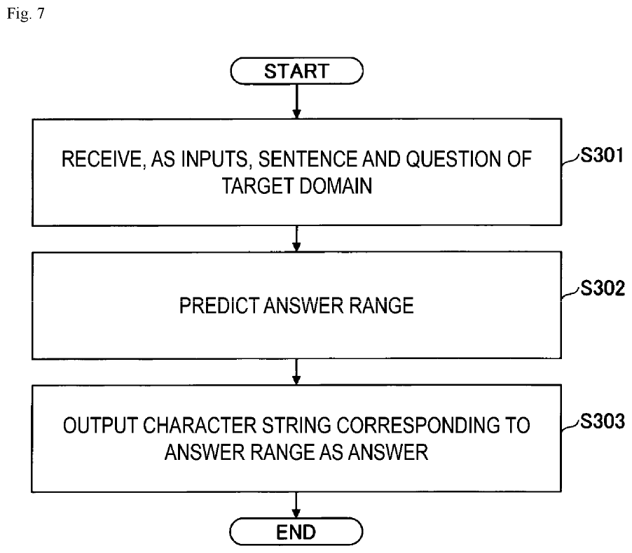

Flow of Question Responding Processing Next, a flow of the question responding processing according to the present embodiment will be described with reference to FIG. 7. FIG. 7 is a flowchart illustrating an example of question responding processing according to the present embodiment. It is assumed that the trained parameters trained in the training processing of FIGS. 5 and 6 are stored in the parameter storage unit 110.

First, the input unit 101 receives, as inputs, a sentence and a question (question sentence) of the target domain (step S301).

Then, the shared model unit 102 and the question responding model unit 103 predict the answer range in the sentence for the question by using the sentence and question (question sentence) input in step S301 above and the trained parameters stored in the parameter storage unit 110 (step S302).

That is, first, the shared model unit 102 receives a token sequence corresponding to the question sentence and the sentence of the target domain (that is, a token sequence consisting of [CLS], a token sequence representing the question sentence, [SEP], a token sequence representing the sentence of the target domain, and [SEP]), and a segment id corresponding to this token sequence (that is, a segment id that has 0s in series from [CLS] to a first [SEP] and is in series from the sentence to a second [SEP]), and uses the parameters stored in the parameter storage unit 110 to output the intermediate expression. Then, the question responding model unit 103 receives, as an input, the intermediate expression output from the shared model unit 102, and uses the trained parameters stored in the parameter storage unit 110 to output the start point position vector and the end point position vector (or output a matrix composed of the start point position vector and the end point position vector). Accordingly, the range specified by a start point indicated by the start point position vector and an end point indicated by the end point position vector is predicted as the answer range in the sentence for the question.

The output unit 106 extracts a character string corresponding to the answer range indicated by the start point position vector and the end point position vector predicted in step S302 from the sentence, and outputs the character string as an answer to a predetermined output destination (step S303).

Experimental Results

Next, experimental results of a scheme of the present embodiment (hereinafter also referred to as a “proposed scheme”) will be described. In the present experiment, a MRQA data set was used. In the MRQA data set, six types of data sets are provided as training data. Further, as evaluation data, six types of data (out-domain) are newly provided, in addition to the same six types of data (in-domain) as those for training. This makes it possible to evaluate the generalization performance or domain dependence of the model using the MRQA data set.

In this experiment, a model in which BERT was fine-tuned was adopted as a baseline model of the proposed scheme. A known BERT-base was used as the BERT. A total number of transformer layers of BERT-base was N=12. Further, in the proposed scheme, k=2, k′=1, and n=3.

Further, a medical domain was defined as the target domain. The medical domain corresponds to BioASQ in out-domain data of the MRQA data set. Further, an abstract of pubmed, which is a database of literature regarding life science, biomedicine, or the like, was collected as the sentence of the target domain.

The experimental results in this case are shown in Tables 1 and 2 below. Table 1 shows experimental results for in-domain evaluation data (that is, evaluation data of the source domain). Table 2 shows experimental results for out-domain evaluation data (that is, evaluation data of the target domain). Each column represents a type of data set, and each row represents an evaluation value in a case in which each of the baseline and the proposed scheme has been evaluated using the data set.

TABLE 1

| in-domain | SQuAD | HotpotQA | TriviaQA | NewsQA | SearchQA | NaturalQuestions |
|---|---|---|---|---|---|---|
| BASELINE | 76.6/85.6 | 53.2/68.5 | 56.8/63.3 | 46.9/62.7 | 61.1/67.4 | 64.2/75.9 |
| PROPOSED | 77.5/86.2 | 54.0/69.8 | 57.8/64.6 | 47.2/62.8 | 61.2/67.6 | 64.4/76.2 |
| SCHEME | | | | | | |

TABLE 2

| out-domain | BioASQ | DROP | DuoRC | RelationExtraction | TextbookQA | RACE |
|---|---|---|---|---|---|---|
| BASELINE | 34.0/49.2 | 27.5/35.8 | 46.4/56.6 | 72.5/84.2 | 44.6/53.7 | 25.5/37.4 |
| PROPOSED | 37.7/52.5 | 29.5/37.3 | 47.0/57.6 | 72.8/83.4 | 44.3/53.2 | 24.9/37.4 |
| SCHEME | | | | | | |

Here, EM (exact match) and F1 (partial match (harmonic mean of precision and recall)) are adopted as evaluation indexes, EM is described on the left side of each cell in the table, and F1 is described on the right side of each cell in the table.

In this case, in the baseline model, overall tendency is that an out-domain data set is not as accurate as an in-domain data set although this depends on the type of data set. This is because the accuracy greatly changes depending on a domain even when BERT is fine-tuned.

On the other hand, in the proposed scheme, the accuracy in BioASQ (target domain) is improved by 3% or more for both EM and F1. This means improvement of the accuracy in the target domain (that is, curbing the deterioration of generalization performance), which is a goal of the proposed scheme.

Further, with the proposed scheme, accuracy in all in-domain data sets is improved by 0 to 1.3% as compared to the baseline model. This means that in the proposed scheme, deterioration in accuracy in the source domain does not occur.

Further, in the proposed scheme, accuracy in a data set of the out-domain other than BioASQ increases by 0 to 2.0% or decreases by 0 to 0.6%. This is attributed to the fact that Textbook QA or RACE whose accuracy has decreases is a data set of a science and education domain for students such as a textbook and the domain is greatly different from a medical domain.

Conclusion

As described above, the question responding device 10 according to the present embodiment shares low layers between the machine reading comprehension model and the language model, and performs multi-task training on a model in which high layers are divided into the machine reading comprehension model and the language model through supervised training and unsupervised training, so that a machine reading comprehension model adapted to the target domain can be obtained. This allows the question responding device 10 according to the present embodiment to realize machine reading comprehension in the target domain with high accuracy through this machine reading comprehension model.

Although the machine reading comprehension task has been assumed and described as an example of a task in the present embodiment, the present embodiment can be similarly applied to any task other than the machine reading comprehension task. That is, the present embodiment can also be applied to a case in which a model in which low layers are shared between a model for realizing a predetermined task and the trained model, and the high layers are divided into the model for realizing a predetermined task and the trained model is subjected to multi-task training through supervised training and unsupervised training.

For example, the present embodiment can be similarly applied to a document abstract task as a task other than the machine reading comprehension task. In this case, training data including a document and a correct abstract sentence is used for fine tuning of a model for realizing the document abstract task (a document abstract model).

The present invention is not limited to the above-described embodiment disclosed specifically, and various modifications or changes, combinations with known techniques, and the like can be made without departing from description of the claims.

### REFERENCE SIGNS LIST

10 Question responding device
101 Input unit
102 Shared model unit
103 Question responding model unit
104 Language model unit
105 Parameter update unit
106 Output unit
110 Parameter storage unit

1. An information processing apparatus comprising:
a processor; and
a memory storing computer executable instructions, which, when executed by the processor, cause the information processing apparatus to:
share encoding layers from a first layer to a (N-n)-th layer having parameters trained in advance by a first model and a second model; and
train parameters of a third model through multi-task training including training of the first model and retraining of the second model for a predetermined task,
wherein N and n are integers equal to or greater than 1, and satisfies N>n, and in the third model, and
encoding layers from an ((N-n)+1)-th layer to an N-th layer having parameters trained in advance are divided into the first model and the second model.

2. The information processing apparatus according to claim 1,
wherein the processor is configured to:
use an error between second data output by inputting first data included in training data of the task to the first model and supervised data included in the training data to update parameters of the encoding layers from the first layer to the (N-n)-th layer shared by the first model and the second model and parameters of the encoding layers from the ((N-n)+1)-th layer to the N-th layer of the first model, and
set data obtained by processing third data as fourth data and supervised data corresponding to the fourth data as fifth data, and use an error between sixth data output by inputting the fourth data to the second model and the fifth data to update the parameters of the encoding layers from the first layer to the (N-n)-th layer shared by the first model and the second model and parameters of the encoding layers from the ((N-n)+1)-th layer to the N-th layer of the second model.

3. The information processing apparatus according to claim 2,
wherein the first data is data belonging to a first domain, and
the third data is data different from the first domain and belonging to a second domain that is a target of the task.

4. The information processing apparatus according to claim 2,
wherein the task is a machine reading comprehension task, and the encoding layers are transformer layers of BERT,
the first data includes a token sequence including a question sentence and a document, and a segment id associated with 0 in the question sentence and 1 in the document, and
the fifth data includes a token sequence in which a part of the sentence represented by the third data is masked and a segment id of all 0s.

5. The information processing apparatus according to claim 1, wherein the processor is configured to output data according to the predetermined task using the parameters trained in advance and data input to the first model.

6. An information processing method comprising:
sharing encoding layers from a first layer to a (N-n)-th layer having parameters trained in advance by a first model and a second model; and
training parameters of a third model through multi-task training including training of the first model and retraining of the second model for a predetermined task,
wherein N and n are integers equal to or greater than 1, and satisfies N>n, and in the third model, and
encoding layers from an ((N-n)+1)-th layer to an N-th layer having parameters trained in advance are divided into the first model and the second model.

7. The information processing method according to claim 6, further comprising:
outputting data according to the predetermined task using the parameters trained in advance and data input to the first model.

8. A non-transitory computable-readable recording medium storing a program storing computer executable instructions, which, when executed by a processor of an information processing apparatus, cause the information processing apparatus to:
share encoding layers from a first layer to a (N-n)-th layer having parameters trained in advance by a first model and a second model; and
train parameters of a third model through multi-task training including training of the first model and retraining of the second model for a predetermined task,
wherein N and n are integers equal to or greater than 1, and satisfies N>n, and in the third model, and
encoding layers from an ((N-n)+1)-th layer to an N-th layer having parameters trained in advance are divided into the first model and the second model.
